(19) United States
(12) Patent Application Publication
(10) Pub. No.: US 2003/0064134 A1
(43) Pub. Date: Apr. 3, 2003

(54) Kit, system and method for preparing home-made nutritional food items

(75) Inventor: Robert Eastman III, Fenton, MI (US)

Correspondence Address: CARRIER BLACKMAN AND ASSOCIATES, 24101 NOVI ROAD, SUITE 100, NOVI, MI, 48375

(73) Assignee: Eastman Outdoors, Flushing, MI

(21) Appl. No.: 09/970,232

(22) Filed: Oct. 3, 2001

(51) Int. Cl. A23L 1/30

(52) U.S. Cl. 426/72

(57) ABSTRACT

A kit for fabricating energy-rich foods includes a base mix and an additive component for adding to the base mix. The additive component includes one or more additives selected from a predetermined group of edible additives and supplements. A method of making nutritional foodstuffs includes steps of adding a measured amount of a base mix to a container, adding an additive component to the base mix, mixing the base mix and the additive component together; and forming the resultant mixture into individual food portions. A system for fabricating energy-rich foods includes at least one base mix and a plurality of additives for selectively adding to the base mix. A user may selectively choose preferred additives from the system to form a kit according to that user's nutritional needs, to customize the food portions for that user.

### BACKGROUND OF THE INVENTION

1. Field of the Invention

The present invention relates to food preparation systems and methods, specifically to the preparation of nutritional foodstuffs by an individual user. More particularly, the present invention relates to a kit, system and method for preparing nutritional food items. According to the invention, an individual user can selectively choose preferred additives and combine them with a chosen base mix to custom-make food items in the user's own home, as desired.

2. Description of the Background Art

Many different types of nutritional foodstuffs are known and are commercially available.

It is also known to add supplements or additives, such as vitamins, to nutritional foodstuffs to increase their beneficial effects. Energy-rich nutritional foodstuffs such as energy bars and trail mix, among other foods, are commercially available. Energy bars are most commonly eaten by athletes and sports enthusiasts, such as skiers, hikers, rock climbers, runners, and cyclists, prior to and during breaks between athletic training sessions and performances.

Examples of some issued patents relating to known energy bars include U.S. Pat. No. 3,814,819 to Morgan, U.S. Pat. No. 3,950,545 to Hayward et al., U.S. Pat. No. 4,859,475 to Michnowski, and U.S. Pat. No. 5,643,623 to Schmitz et al.

Although the known nutritional foodstuffs are useful for their intended purposes, a need still exists in the art for a system and method that would allow individual users to customize nutritional foodstuffs to fit their specific goals or requirements.

In particular, there is a need for an energy foodstuff kit, system and method that would provide a base mix and a number of useful additives for selectively combining with the base mix, according to a user's preferences. Preferably, such a kit, system and method would enable an individual user to select the components that were most beneficial for that user's particular goals or requirements, and to selectively purchase suitable supplies to enable the user to make custom-mixed foodstuffs of his or her liking, at home, as needed.

### SUMMARY OF THE INVENTION

The present invention provides a kit, system and method for allowing a user to custom-select preferred ingredients to make nutritional foodstuffs, suitable for that user's particular goals or requirements, and which will enable the user to make such foodstuffs, as needed, in the user's own kitchen. Nutritional food portions, according to the present invention, may either be in the form of a concentrated bar, or a loose aggregate.

A nutritional foodstuff fabricating system, in accordance with the present invention, includes a first component which includes a base mix, and a second component comprising at least one additive.

The base mix may be carbohydrate-rich, protein-rich, or may contain a mixture of both protein and carbohydrates.

The additive(s) for forming the second component may be selected from the group comprising vitamin supplements, mineral supplements, herbal supplements, anti-oxidants, protein supplements, edible fiber additives, edible seeds, fruit products, nuts, nut products, and mixtures of the above.

In one particular embodiment of the invention, a carbohydrate-rich base mix preferably includes oats and/or an oat product such as oat flour, oat germ or oat bran. The carbohydrate-rich base mix of this particular embodiment may also include additional grains or grain products, as desired. Examples of some possible additional grain products include wheat flour, wheat bran, wheat germ, graham flour, rice flour, puffed grain (rice, wheat or corn), soy flour, corn products, etc.

Preferably, the system hereof also includes a sweetener for adding to the base mix. The sweetener may be selected from a group comprising honey, sugars, molasses, syrups, artificial sweeteners, and mixtures thereof.

Other additives such as flavorings, spices, vanilla, carob, chocolate or other flavor chips, etc. may be added to the mixture without departing from the scope of the invention.

The present invention also provides a method of making nutritional foodstuffs, including the steps of:

a) adding a measured amount of a first component, which is a base mix comprising a carbohydrate, a protein or a mixture of carbohydrate and protein, to a container;

b) adding a second component to the base mix in the container, the second component comprising at least one additive selected from the group comprising protein supplements, vitamin supplements, mineral supplements, herbal supplements, anti-oxidants, edible fiber additives, fruit products; nuts, nut products, and mixtures thereof;

mixing the ingredients together; and

forming the resultant mixture into individual serving portions.

The individual serving portions may be in the form of energy bars, or may be a measured amount of a loose aggregate of edible material, placed into an appropriate container.

The method may involve a cooking step, which may be carried out using a microwave or radiant oven.

The method may further include a step of adding a sweetener to the mixture. The method may still further include a step of consulting a nutritional guide to determine appropriate amounts of the additives to use.

A method according to the invention may, optionally, involve a step of placing individual serving portions of the mixture into a mold having cutout recesses of a standard size formed therein. The use of a standardized mold allows a user to reproducibly make food portions of a consistent volume and nutritional value.

Accordingly, it is an object of the present invention to provide a system and method for making nutritional foodstuffs, which will allow a user to combine a standardized base mix with selected additional ingredients.

It is a further object of the present invention to provide a kit, system and method that will allow a user to select preferred ingredients, to customize foodstuffs according to the user's preferred needs and requirements. Preferably, a system and method of this type could allow a user to make nutritional foodstuffs of a desired quantity and content, in the user's own home.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a perspective view of a homemade nutritional energy bar made according to the kit, system and method of the present invention;

FIG. 2 is a schematic diagram showing exemplary components which are selectively usable to make nutritional energy foodstuffs according to the present invention; and

FIG. 3 is a perspective view of a standardized molding pan usable in making nutritional energy bars according to the system and method of the present invention.

### DETAILED DESCRIPTION OF THE PREFERRED EMBODIMENT

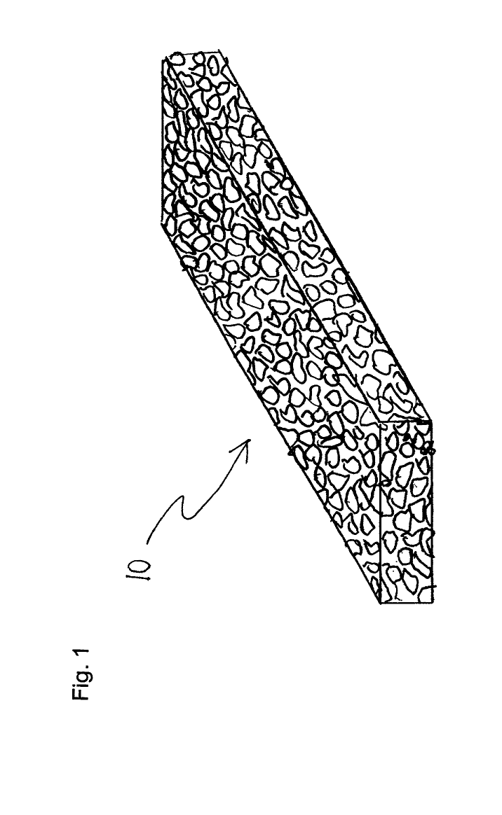

Referring now to the drawings, one illustrative example of a nutritional energy bar, as an example of a foodstuff in accordance with the present invention, is shown generally at 10 in FIG. 1.

As previously noted, energy bars have become popular for consumption by athletes, such as bicycle riders and runners, prior to and during breaks between athletic training and performances, to provide and maintain performance energy.

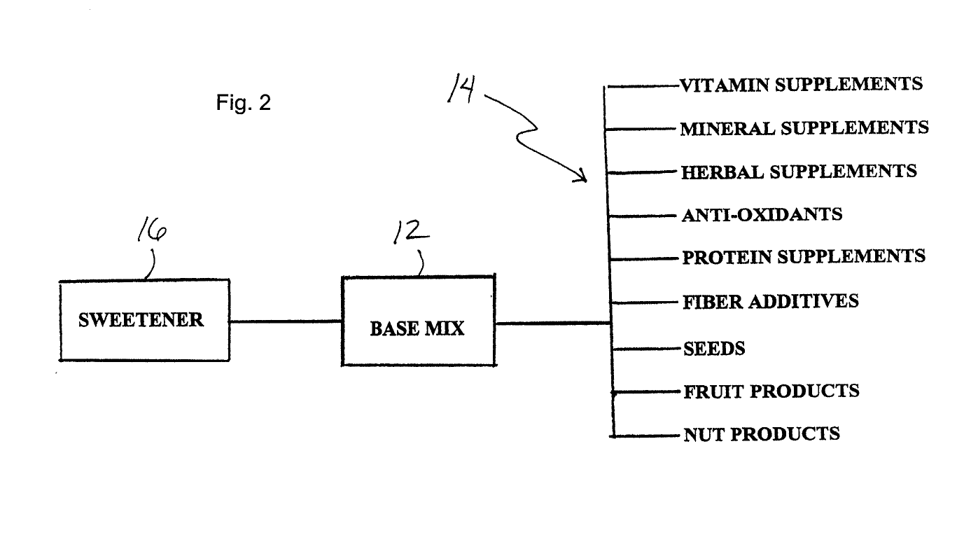

The present invention provides a kit, system and method for allowing a user to form energy foodstuffs at home, in a desired quantity, from a mixture which includes a base mix 12 (FIG. 2) and at least one additive selected from a group of additives 14.

A kit according to the present invention includes a measured amount of a base mix 12 and a measured amount of at least one additive for combining with the base mix. In one embodiment of the invention, the base mix and additive may be mixed together in a dry mixture.

A system according to the present invention preferably includes a pre-manufactured base mix 16, and at least three potential additives 14, from which a user may selectively choose. Preferably, the system includes a large number of additives.

The Base Mix

The base mix may include a carbohydrate source, a protein source, or both of these.

In one embodiment of the invention, the base mix includes a grain product. The base mix of this particular embodiment preferably includes oats and/or an oat product such as oat flour, oat germ or oat bran. The base mix may also include a seasoning such as salt. The base mix may include additional grains or grain products, as desired. Examples of some possible additional grain products may include wheat flour, wheat bran, wheat germ, graham flour, rice flour, puffed rice, soy flour, corn products, etc. Optionally, the base mix may further include a leavening agent, such as baking soda.

In another embodiment of the invention, the base mix is preferred to be a proteinaceous base mix. Optionally, the proteinaceous base mix may include proteins in combination with carbohydrates. Usable proteins include whey protein isolate, soy protein, sodium caseinate, and calcium caseinate.

Optionally, the base mix may include a binder. Examples of suitable binders, which may be optionally used in connection with the present invention, include pectin and gelatins.

The base mix may be pre-measured and provided in prepackaged containers, such as plastic bags, containing a standardized measured amount.

Additives

Useful additives for combining with the base mix include vitamin supplements, mineral supplements, herbal supplements, antioxidants, protein supplements, edible fiber additives, edible seeds, binders, fruits and fruit products, nuts, and nut products such as nut butter.

These additives may be used individually, or in any combination or mixture thereof. Where herbal supplements are used as additives, examples of some usable herbal supplements include Acerola, Astragalus, Bilberry, Butcher's Broom, Chamomile, Echinacea, Garlic, Ginger, Ginkgo Biloba, Ginseng, Gotu Kola, Green Tea Extract, Guarana, Hawthorn Berries, Saw Palmetto, St John's Wort, and Yerba Mate.

The above-listed additives are provided as examples, and the above list is intended to be illustrative rather than restrictive or all-inclusive. Other additives in addition to those listed may be used without departing from the scope of the invention.

Preferably, the mixture, for making the energy foodstuffs 10, also includes a sweetener 16. Where used, the sweetener 16 may be selected from sugars, honey, syrups, molasses, artificial sweeteners, and mixtures of the above.

Method of Making Foodstuffs

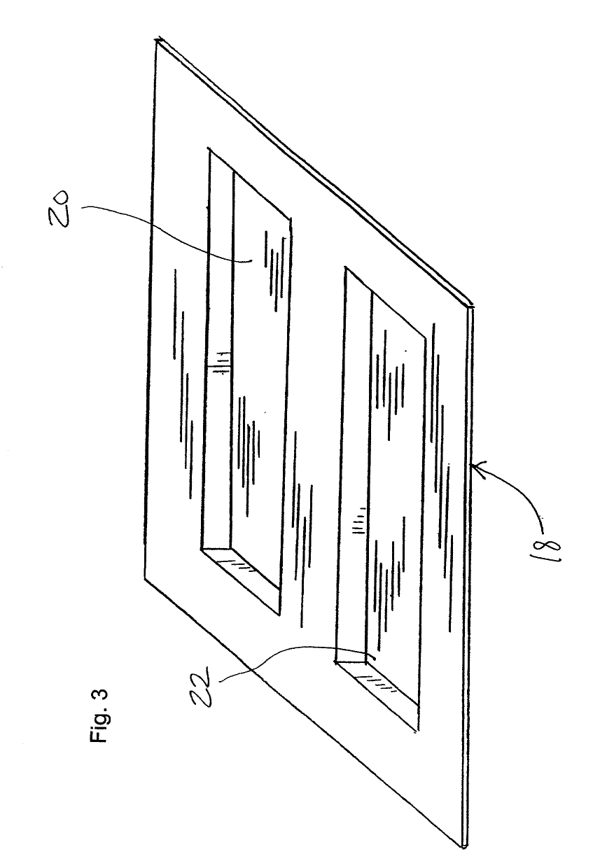

In forming the mixture for the energy foodstuffs 10, the base mix is blended with a sweetener 16 as desired, and then the selected additives 14, which the user would like to include in the foodstuffs, are added. If all of the ingredients are dry, a liquid such as water, cow's milk or soy milk may be added to bring the mixture to a desired consistency. The mixture is stirred to make it substantially consistent throughout, and is then placed into standard-sized recesses 20, 22 in a standardized foodstuff mold 18 (FIG. 3).

This use of a standardized foodstuff mold 18 allows the user to determine the nutritional content of the individual foodstuffs 10.

After the mixture is placed into the foodstuff mold 18, depending on the type of energy foodstuff desired, the foodstuffs may be allowed to set at room temperature. Alternatively, the mold 18 may be placed into the refrigerator overnight. Another alternative is that the mold 18 may be made of an oven-proof material such as a metal with a non-stick coating, and the individual portions may be baked in a radiant oven, for a time period between 15 and 40 minutes at a temperature between 250 and 350 degrees F. Still another alternative treatment is that the mold 18 may be made of a microwave-safe material and the individual portions may be cooked in a microwave oven. The treatment given will depend on the ingredients selected, and on the type of energy foodstuff desired.

Nutritional Guide

It is contemplated that in following the system and method according to the invention, a nutritional guide is provided to assist a user in correlating specific quantities of additives with the nutritional values provided by those additives. Preferably, this guide could be provided in chart form. The user should work from a standard batch size, so that appropriate measured amounts of the additives may be added to the standard batch, and these amounts will correspond to amounts on the nutritional guide.

### EXAMPLES

The following examples are provided to illustrate, rather than to limit, specific examples of energy foodstuffs made following the system and method hereof. Throughout the following examples, all parts are by weight of the total mixture, unless otherwise stated.

### Example 1

A base mix is prepared using 1 part rolled oats, finely chopped in a blender and mixed with ½ part toasted wheat germ.

Then, 1 part chopped almonds, 1 part corn syrup, and 1 part peanut butter are added to the base mix, and the resultant mixture is mixed thoroughly.

Then, 1 part raisins and 1 part chopped dried apricots are added with further mixing.

The resultant mixture is formed into foodstuffs in a foodstuff mold, heated in an oven set to about 250 degrees for 15 minutes, and allowed to cool. Each foodstuff is then wrapped in wax paper and stored under refrigeration.

### Example 2

A base mix is prepared using 1 part rolled oats, finely chopped in a blender and mixed with ½ part oat bran and ½ part whole wheat flour, with small amounts of salt and baking soda.

Then, 1 part honey, 1 part chopped raisins, and 1 part chopped peanuts, and ½ part chopped roasted sunflower seeds are added, along with ⅛ part carob powder and ¼ part ginkgo biloba as a supplement.

½ part water is added to hold the ingredients together, and all of the ingredients are mixed well.

Then, portions of the mixture are added to standardized recesses in a foodstuff mold, and baked at 350 degrees for 30 minutes.

### Example 3

A proteinaceous base mix is prepared using 6 parts whey protein isolate, 7 parts soy protein, 15 parts wheat flour, and 20 parts soy flour.

Then, 25 parts calcium caseinate, 12 parts cooked brown rice, 2.5 parts fructose, 9 parts white sugar, 7 parts brown sugar, 3 parts cocoa powder, 7 parts whey powder, ½ part lecithin, 0.1 part vanilla extract and 10.65 parts roasted peanuts are combined with, and added to the base mix to provide an enhanced base mix. Selected additives may be added to this enhanced base mix, as desired.

### Example 4

A carbohydrate-rich base mix is prepared using 10 parts fructose solids, 12 parts oat bran, 20 parts soy flour, 12 parts wheat flour, 3 parts milk protein and 7 parts rolled oats. To this base mix is added 4 parts cocoa powder, 8 parts brown rice, 8 parts chocolate chips, 2 parts caramel flavor, 6 parts white sugar, and 8 parts brown sugar, to provide an enhanced base mix. Selective additives may be added to this enhanced base mix, as desired.

Although the present invention has been described herein with respect to a preferred embodiment thereof, the foregoing description is intended to be illustrative, and not restrictive. Those skilled in the art will realize that many modifications of the preferred embodiment could be made which would be operable. All such modifications which are within the scope of the claims are intended to be within the scope and spirit of the present invention.

Having, thus, described the invention, what is claimed is:

1. A kit for use in preparing energy-rich foodstuffs, comprising:
a measured amount of a base mix comprising a protein source, a carbohydrate source, or a mixture thereof;
a measured amount of an additive component for selectively adding to the base mix, the additive component comprising at least one additive selected from the group comprising protein supplements, vitamin supplements, mineral supplements, herbal supplements, anti-oxidants, edible fiber additives, fruit products; edible seeds; nuts, nut products, and mixtures thereof

2. The kit of claim 1, further comprising a sweetener selected from the group comprising sugars, honey, molasses, syrups, artificial sweeteners, and mixtures thereof.

3. The kit of claim 1, further comprising a mold having a plurality of hollow recesses formed therein, each of the recesses having a standard volume.

4. The kit of claim 1, further comprising a nutritional guide to assist a user in evaluating nutritional values of selected ingredients.

5. The kit of claim 1, wherein said additive component comprises an herbal supplement selected from the group consisting of Acerola, Astragalus, Bilberry, Butcher's Broom, Chamomile, Echinacea, Garlic, Ginger, Ginkgo Biloba, Ginseng, Gotu Kola, Green Tea Extract, Guarana, Hawthorn Berries, Saw Palmetto, St John's Wort, and Yerba Mate.

6. A kit for use in fabricating energy-rich foodstuffs, comprising:
a base mix comprising a protein source, a carbohydrate source, or a mixture thereof;
a sweetener selected from the group comprising sugars, honey, molasses, syrups, artificial sweeteners, and mixtures thereof;
an additive component for selectively adding to the base mix, the additive component comprising at least two additives selected from the group comprising vitamin supplements, protein supplements, mineral supplements, herbal supplements, anti-oxidants, edible fiber additives, fruit products, edible seeds, nuts, nut products, and mixtures thereof.

7. The kit of claim 6, further comprising a mold having a plurality of hollow recesses formed therein, each of the recesses having a standard volume.

8. The kit of claim 6, further comprising a nutritional guide to assist a user in evaluating nutritional values of selected ingredients.

9. The kit of claim 6, wherein said additive component comprises an herbal supplement selected from the group consisting of Acerola, Astragalus, Bilberry, Butcher's Broom, Chamomile, Echinacea, Garlic, Ginger, Ginkgo Biloba, Ginseng, Gotu Kola, Green Tea Extract, Guarana, Hawthorn Berries, Saw Palmetto, St John's Wort, and Yerba Mate.

10. A method of making nutritional foodstuffs, comprising the steps of:
a) adding a measured amount of a premixed base mix to a container; said base mix comprising a protein source, a carbohydrate source, or a mixture thereof;
b) adding a measured amount of a second component to the base mix, the second component comprising at least one additive selected from the group comprising protein supplements, vitamin supplements, mineral supplements, herbal supplements, antioxidants, edible fiber additives, fruit products; edible seeds; nuts, nut products, and mixtures thereof;
mixing the base mix and the second component together to form a mixture; and
dividing the mixture into individual portions.

11. The method of claim 10, further comprising a step of adding a sweetener to the base mix, said sweetener selected from the group comprising sugars, honey, molasses, syrups, artificial sweeteners, and mixtures thereof.

12. The method of claim 10, wherein the dividing step is performed using a hollow recess in a standardized foodstuff mold.

13. A nutritional foodstuff which is a product of the method of claim 10.

14. The method of claim 12, wherein the individual portions are energy bars.

15. The method of claim 12, further comprising a step of cooking the individual portions.

16. The method of claim 15, wherein the cooking step is performed using a microwave oven.

17. The method of claim 15, wherein the cooking step is performed using a radiant oven.

18. A system for use in fabricating energy foodstuffs, comprising:
a base mix comprising a protein source, a carbohydrate source, or a mixture thereof;
an additive group for selectively adding to the base mix, the additive group comprising at least three additives selected from the group comprising:
at least one additive selected from the group comprising protein supplements, vitamin supplements, mineral supplements, herbal supplements, anti-oxidants, edible fiber additives, fruit products; edible seeds; nuts, nut products, and mixtures thereof

19. The system of claim 18, wherein the additive group comprises a plurality of herbal supplements selected from the group consisting of Acerola, Astragalus, Bilberry, Butcher's Broom, Chamomile, Echinacea, Garlic, Ginger, Ginkgo Biloba, Ginseng, Gotu Kola, Green Tea Extract, Guarana, Hawthorn Berries, Saw Palmetto, St John's Wort, and Yerba Mate.

20. The system of claim 18, further comprising a sweetener.

21. A composition for use by a consumer in making an energy-rich foodstuff, said composition being a substantially dry mixture comprising:
a measured amount of a base mix comprising a protein source, a carbohydrate source, or a mixture thereof; and
a measured amount of an additive component intermixed with the base mix, the additive component comprising at least one additive selected from the group consisting of herbal supplements, anti-oxidants, and mixtures thereof.
